(19) United States
(12) Patent Application Publication
(10) Pub. No.: US 2018/0201552 A1
(43) Pub. Date: Jul. 19, 2018

(54) Plant Nutrient Suspensions And Use Thereof For Fertilising Plants

(71) Applicant: Clariant International Ltd., Muttenz (CH)

(72) Inventors: Robert MILBRADT, Wiesbaden (DE); Peter BAUR, Schondorf (DE); Gerd SCHWEINITZER, Frankfurt am Main (DE)

(73) Assignee: Clariant International Ltd., Muttenz (CH)

(21) Appl. No.: 15/746,303

(22) PCT Filed: Jul. 20, 2016
(86) PCT No.: PCT/EP2016/067312

§ 371 Date: Jan. 19, 2018

(30) Foreign Application Priority Data
Jul. 20, 2015 (DE) 10 2015 213 635.3

(51) Int. Cl. C05G 3/06; C05G 3/02; C05G 3/00; C05D 3/00; C05B 7/00

(52) U.S. Cl. CPC C05G 3/06; C05G 3/02; C05B 7/00; C05D 3/00; C05G 3/007

(57) ABSTRACT

The invention relates to suspensions containing: i) one or more plant nutrients; ii) one or more specific homo- or copolymers; iii) one or more solvents; and iv) optionally one or more additional auxiliary materials. The homo- or copolymers contain recurring structure units of formula (I), wherein R₁ represents hydrogen or methyl, A represents C₂-C₄-alkyls, B represents a C₂-C₄-Alkyl that is different from A, m is a number from 0 to 500, n is a number from 0 to 500, and the sum of m+n is equal to 1 to 1000, and Pₐ represents hydrogen, an acid group or the salt thereof, or represents the monovalent organic group containing one or two acid groups or the salts thereof. The suspensions according to the invention are advantageously suitable for supplying plants with one or more plant nutrients.

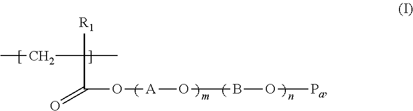

The present invention relates the suspensions comprising selected polymers and to the use thereof for fertilization of plants.

As well as the known macronutrients (N, P, K), plant crops require further nutrients for optimal development, especially the secondary nutrients Mg and S, which are frequently applied as foliar fertilizers in dissolved form.

In agricultural practice, foliar fertilization with magnesium sulfate is considered to be “good practice” in order to remedy situations of time-related deficiency with these nutrients via direct application to the leaf with relatively small amounts of nutrient immediately and without any great delay.

As well as the nutrients mentioned, further trace elements that are present in small amounts, such as Fe, Mn, Zn, Cu, Co, Mo and B, called the micronutrients, are indispensable. These trace elements are essential for the construction of enzyme systems in plant cells and are frequently not available to a sufficient degree. Undersupply with these micronutrients leads to depressions in yield as a result of deficiency diseases in the plant. The need for the latter elements is directly connected to the level of fertilization with macronutrients. The better the plants are supplied with N, P, K, Ca and Mg, the greater the need for trace elements. However, exceedance of the optimal dose can likewise lead to damage and yield losses. (Ullmanns Encyklopädie der technischen Chemie [Ullmann's Encyclopedia of Industrial Chemistry], 4th edition 1975, volume 10, page 206).

These macronutrients, secondary nutrients and micronutrients, in the context of this description, are among the plant nutrients.

Plant nutrients are typically used in the form of preparations in order to achieve improved exploitation. Preparations of this kind are also referred to as formulations and are generally in solid or liquid form. Liquid preparations of plant nutrients have the advantage that they are easily dosable for the user and distributable homogeneously in a spray liquor. Some plant nutrients have only low solubility in water or in other solvents, or should be in concentrated form at least during storage and transport. Therefore, plant nutrients are appropriately provided in dispersed form as suspension concentrates.

One example of this is given in the document DE 30 04 631 A1. Further suspension concentrates comprising active agrochemical ingredients can be found in DE 101 29 855 A1, DE 10 2004 011 007 A1 and DE 600 15 824 T2.

Stabilization of active ingredients, as of plant nutrients, in suspension concentrates requires dispersants. These dispersants, optionally assisted by suitable surface-active substances (wetting agents), enable the production of the suspension concentrate, which is generally accomplished with the aid of grinding, in order to introduce high mechanical forces into the system. After the grinding operation, the dispersants have a stabilizing effect on the system by virtue of steric or electrostatic interactions. Dispersants may have an anionic, cationic, amphoteric or neutral structure. They may be low molecular weight in nature or may be polymers of higher molecular weight that form a random, alternating, block-like, comb-like or star-shaped architecture of the polymerized monomers.

Examples of commercially significant dispersants, which are used in large volumes for production of suspension concentrates, are sulfonated condensation products of alkylnaphthalenes with formaldehyde (naphthalenesulfonates) or lignosulfonates. However, these products no longer meet current demands with regard to toxicological nonmaleficence and user safety, since they are irritating to the skin and eyes. Moreover, these dispersants are not particularly effective, i.e. relatively large volumes are required to obtain stable suspension concentrates.

EP 0 007 731 A2 describes the use of copolymers as dispersants in suspension concentrates.

WO 2008/015185 A2 describes copolymers which consist of acrylic acids, 2-acrylamido-2-methylpropanesulfonic acid and acrylic esters in particular ratios and which are suitable as dispersants for pesticide formulations.

WO 2008/138486 A1 discloses anionic water-soluble additives. These are anionically modified copolymers which are obtained by polymerization of (meth)acrylate polyalkylene glycol esters with ethylenically unsaturated monomers containing an aromatic group and ethylenically unsaturated monomers containing an alkyl radical, which are subsequently functionalized by conversion of terminal hydroxyl groups to anionic end groups. These copolymers can be used as dispersants, especially for pigments and fillers.

EP 1,379,129 B1 discloses pesticide formulations comprising copolymers. These comprise copolymers obtainable by copolymerization of glycerol, at least one dicarboxylic acid and at least one monocarboxylic acid, containing, as well as the carboxyl group, a C₅-C₂₉-alkyl radical, a C₇-C₂₉-alkenyl radical, a phenyl radical or a naphthyl radical. The presence of these copolymers in pesticide formulations enhances the pesticidal action of crop protection compositions.

WO 2008/036864 A2 discloses the use of water-soluble copolymers as dispersants for water-soluble active ingredients.

WO 2010/121976 A2 describes dispersants for pesticide formulations based on a copolymer containing 2-acrylamido-2-methylpropanesulfonic acid.

WO 2008/138485 A1 describes nonionic water-soluble additives which can be used as dispersants for pigments. WO 2008/138486 A1 describes anionic water-soluble additives which can be used as dispersants for pigments. There is no description of use as dispersants for pesticides.

WO-A-2012/123094 A2 describes dispersants for suspension concentrates comprising pesticides. These dispersants, even in small amounts, enable sufficient stabilization of the suspension concentrate and feature an advantageous toxicological profile. There is no description of production of suspension concentrates comprising plant nutrients.

Plant nutrients are frequently active electrolyte ingredients which can lead to problems when used in high concentrations in suspensions, for example with storage stability or redispersibility. In oversaturated solutions of the active electrolyte ingredients, there can be sedimentation and caking, such that the formulations are no longer readily free-flowing or no longer dilutable by simple stirring or agitation with water.

US-A-2009/022331 A1 discloses homogeneous, stable and water-soluble suspension concentrates of plant nutrients. These contain, as well as a mineral plant nutrient in an amount of at least 80% by weight of the suspension and an organic stabilizing additive. These include a wide variety of different substance classes, such as cellulose, chitosan or malt.

What have now surprisingly been found are formulations of suspensions of plant nutrients which, even at high active ingredient concentration, exhibit high storage stability and good redispersibility and can be processed by diluting with water to give spray liquors. These formulations are highly active, feature a very advantageous ecological profile, promote solubilization and enable the production of stable suspensions with high electrolyte content.

The present invention relates to suspensions comprising
i) one or more plant nutrients,
ii) one or more homo- or copolymers containing 1 to 100 mol % of repeat structural units of the formula (I)

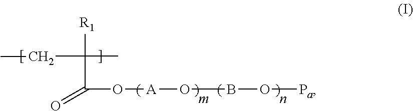

0 to 80 mol % of repeat structural units of the formula (II)

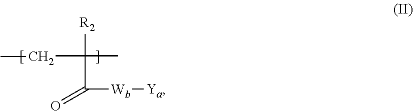

0 to 20 mol % of repeat structural units of the formula (III)

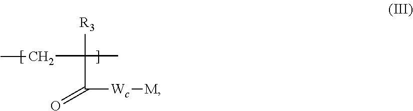

0 to 80 mol % of repeat structural units of the formula (IV)

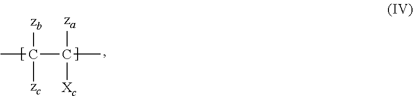

in which
R₁, R₂, and R₃ are independently hydrogen or methyl,
A is C₂-C₄-alkylene,
B is a C₂-C₄-alkylene other than A,
m is a number from 0 to 500,
n is a number from 0 to 500, and
the sum of m+n is 1 to 1000,
Pₐ is hydrogen, is an acidic group or salt thereof or is the monovalent organic radical containing one or two acidic groups or salts thereof,
W_{b} and W_{c} are independently oxygen or the NH group,
Yₐ and X_{c} are independently a monovalent hydrocarbyl radical, especially an aliphatic, aromatic or araliphatic radical optionally containing one or more of the heteroatoms N, O and S,
M is hydrogen or a monovalent metal cation, NH₄⁺, a primary, secondary, tertiary or quaternary ammonium cation, or a combination thereof, or is equivalents of di-, tri- or polyvalent metal cations, and
zₐ, z_{b} and z_{c} are independently hydrogen or (C₁-C₄)-alkyl, with the proviso that the sum total of the repeat structural units of the formula (I), (II), (III) and/or (IV), based on the overall homo- or copolymer, is at least 80 mol %,
iii) one or more solvents, and
iv) optionally one or more further auxiliaries.

“Plant nutrients” in the context of the present invention are understood to mean substances or substance mixtures which are used in agriculture or horticulture to supplement the nutrient supply for the crop plants being grown. Plant nutrients are alternatively also referred to in the context of the present description as fertilizers. The plant nutrients include organic fertilizers and especially mineral fertilizers or organomineral fertilizers.

Examples of organic fertilizers are fertilizers composed of natural substances such as algae extract, blood meal, feather meal, fish meal, green fertilizers, guano, liquid manure, hair meal, urea, horn shavings, manure slurry, composted plant residues, sewage sludge, compost, bone meal, lupin meal, manure, mulch, nettle water, animal meal, green fertilizers or vinasse.

Mineral fertilizers can be used as single fertilizers, for example as potassium sulfate, or as multinutrient fertilizers. Mineral multinutrient fertilizers containing the main nutrient elements nitrogen (N) phosphorus/phosphate (P) and potassium are called compound fertilizers. Many of these compound fertilizers additionally contain sulfur, calcium and/or magnesium and trace elements. The latter are also available as specific trace element fertilizers.

Plant nutrients used with preference in the context of the present invention are synthetic fertilizers. These are understood to mean fertilizer products that are produced synthetically. These fertilizers may comprise constituents of inorganic and/or mineral origin or they may come from an organic source.

Plant nutrients used with preference as component i) are mineral fertilizers. The fertilizing elements therein are usually in the form of salts or in the form of ammonia dissolved in water (“liquid ammonia fertilizers”).

Phosphates are used in principle in the form of rock phosphates or especially in the form of digested phosphates. Rock phosphates are sparingly soluble and are less preferably used as fertilizers. Typically, rock phosphates are digested with sulfuric acid or phosphoric acid, which gives rise to calcium hydrogenphosphate or, in the case of sulfuric acid, additionally also to calcium sulfate. Sulfuric acid-digested rock phosphate is referred to as superphosphate. Phosphoric acid-digested rock phosphate is referred to as triple superphosphate or as double superphosphate and has a higher content of phosphorus. Sparingly soluble CaNaPO₄*CaSiO₄ serves as a long-term fertilizer and is dissolved by organic acids from the roots. Nitrogen-containing phosphate fertilizers, for example diammonium phosphate (NH₄)₂HPO₄ (“ammonium phosphate”) or monoammonium phosphate, are produced from ammonia and phosphoric acid.

The fertilizers preferred as plant nutrients of component i) include the nitrogen fertilizers. These are preferably ammonium nitrate, ammonium sulfate and potassium nitrate.

The fertilizers that are likewise preferred as plant nutrients of component i) include the potash salts. These are obtained in mining, processed (for example as potassium chloride fertilizers) or converted to potassium sulfate.

The plant nutrients of component i) that are likewise used with preference include micronutrient fertilizers containing trace elements in the form of single-trace nutrient fertilizers or in the form of multi-trace nutrient fertilizers. The trace elements are predominantly heavy metals. These are typically used in the form of cations or metal chelate, or in the case of boron in anionic form as borate.

Examples of single-trace nutrient fertilizers used with preference are
Fe-containing fertilizers, especially in the form of iron ethylenediaminetetraacetate,
Mn-containing fertilizers, especially in the form of manganese sulfate MnSO₄.4H₂O or in the form of MnSO₄.H₂O,
Zn-containing fertilizers, especially in the form of zinc sulfate ZnSO₄.7H₂O or in the form of ZnSO₄.H₂O,
Cu-containing fertilizers, especially in the form of copper chelate,
Co-containing fertilizers, especially in the form of cobalt chelate,
Mo-containing fertilizers, especially in the form of a mixture of sodium molybdate and ammonium molybdate,
B-containing fertilizers, especially in the form of sodium tetraborate or boric acid,
calcium-containing fertilizers, especially in the form of calcium formate or other sparingly soluble calcium salts of suitable organic acids, for example acetic acid, propionic acid, lactic acid, tartaric acid, malic acid, succinic acid and citric acid.

These aforementioned single-trace nutrient fertilizers are preferably used in their water-dissolved form as foliar fertilizers.

Preference is additionally given to the use of the single-trace nutrient fertilizers mentioned in various combinations as multi-trace nutrient fertilizers. This has the advantage of a broader spectrum of action.

Plant nutrients of component i) that are used with particular preference contain trace elements in combination with the most important main nutrients nitrogen and/or potassium and/or phosphorus.

Further plant nutrients of component i) that are used with particular preference contain trace elements in combination with the most important main nutrients, such as nitrogen. In addition, a water-soluble combination of multiple micronutrients with the secondary nutrients magnesium and sulfur is known as a foliar fertilizer.

Preferred plant nutrients of component i) are solid at room temperature (25° C.).

Particular preference is given to suspensions comprising plant nutrients that are solid at room temperature, wherein the amount of the one or more plant nutrients of component i) is greater than the solubility thereof at room temperature (25° C.) in component iii), and wherein the one or more plant nutrients i) are partly in dissolved form and partly in undissolved form in the suspension at 25° C.

In further particularly preferred suspensions of the invention, the one or more plant nutrients of component i) are selected from the group consisting of soluble calcium salts having a solubility of more than 1 g/liter at pH values of 3.0 to 6.5. These salts include calcium formate, the calcium salt of other organic acids, for example acetic acid, propionic acid, lactic acid, tartaric acid, malic acid, succinic acid and citric acid, or calcium chloride, calcium nitrate and combinations of calcium salts with acidic ammonium salts or addition compounds. Particular preference is given to calcium formate.

Very particularly preferred suspensions of the invention comprise one or more plant nutrients of component i), comprising one or more elements selected from the group consisting of boron, calcium, iron, potassium, copper, magnesium, manganese, phosphorus, sulfur, selenium, nitrogen and zinc.

Further very particularly preferred suspensions of the invention comprise one or more plant nutrients of component i), selected from the group consisting of ammonium chloride, ammonium nitrate, ammonium sulfate, borax, calcium formate, urea, copper sulfate, manganese nitrate, manganese oxide, manganese sulfate, zinc sulfate and mixtures of two or more of these compounds.

Even further preferred suspensions of the invention comprise at least two different plant nutrients of component i), at least one of which has a solubility in water of more than 50 g/L at 25° C.

The plant nutrient having a solubility in water of more than 50 g/L at 25° C. is preferably a compound selected from the group of the water-soluble salts based on at least one of the cations ammonium, sodium, potassium, magnesium, and of at least one of the anions nitrate, chloride, sulfate, phosphate, polyphosphate and/or urea.

The amount of component i) in the suspension of the invention is generally 20% to 80% by weight, preferably from 30% to 70% by weight and especially from 30% to 50% by weight. These amounts are based on the total mass of the corresponding suspension of the invention.

In the context of the present invention, the homo- or copolymers used as component ii) that contain the repeat structural units of the formula (I) and optionally of the formulae (II), (III) and/or (IV) and/or optionally further repeat structural units derived from an ethylenically unsaturated monomer that does not form any of the structural units of the formulae (I) to (IV), in which Pₐ represents hydrogen are referred to as nonionic copolymers, and the copolymers that contain the repeat structural units of the formula (I) and optionally of the formulae (II), (III) and/or (IV) and/or optionally further repeat structural units derived from an ethylenically unsaturated monomer that does not form any of the structural units of the formulae (I) to (IV), in which Pₐ has a definition other than hydrogen are referred to as anionic copolymers.

The sum total of the repeat structural units of the formula (I) and optionally of the formulae (II), (III) and/or (IV) of the homo- or copolymers used as component ii) in the context of the present invention is at least 80 mol %, preferably at least 90 mol % and more preferably at least 95 mol %.

Components ii) used with preference in accordance with the invention are copolymers containing 1 to 80 mol % of repeat structural units of the formula (I), more preferably 10 to 80 mol % of repeat structural units of the formula (I), and most preferably 20 to 60 mol % of repeat structural units of the formula (I).

Further components ii) used with preference in accordance with the invention are copolymers containing, as well as the repeat structural units of the formula (I), 0.1 to 80 mol % of repeat structural units of the formula (II), more preferably 1 to 70 mol % of repeat structural units of the formula (II), and most preferably 10 to 60 mol % of repeat structural units of the formula (II).

Further components ii) used with preference in accordance with the invention are copolymers containing, as well as the repeat structural units of the formula (I), 0 to 10 mol % of repeat structural units of the formula (III), and more preferably 0 to 5 mol % of repeat structural units of the formula (III).

Further components ii) used with preference in accordance with the invention are copolymers containing, as well as the repeat structural units of the formula (I), 0.1 to 80 mol % of repeat structural units of the formula (IV), more preferably 1 to 70 mol % of repeat structural units of the formula (IV), and most preferably 10 to 60 mol % of repeat structural units of the formula (IV).

As component ii) used in accordance with the invention, copolymers may contain, as well as the repeat structural units of the formula (I) and any repeat structural units of the formulae (II), (III) and/or (IV) present, also repeat structural units R₄ which are from an ethylenically unsaturated monomer that does not form any of the structural units of the formulae (I) to (IV). The proportion of these repeat structural units R₄, based on the copolymer, is up to 20 mol %, preferably 0 to 10 mol % and more preferably 0 to 5 mol %.

Copolymers used with particular preference as component ii) contain 20 to 60 mol % of repeat structural units of the formula (I), 10 to 60 mol % of repeat structural units of the formula (II), 0 to 5 mol % of repeat structural units of the formula (III), and 10 to 60 mol % of repeat structural units of the formula (IV).

The above-defined A and B radicals have the structure —CₚH₂ₚ— and are different within the scope of the definitions given. In this structure, p is an integer from 2 to 4, preferably 2 or 3.

The indices m and n are independently integers in the range from 0 to 500, where the sum of m and n must be at least 1; preferably, the indices m and n are independently integers from 1 to 50.

The sum of m and n is an integer from 1 to 1000, preferably from 2 to 500, more preferably from 2 to 100 and especially preferably from 5 to 100.

The above-defined Pₐ radical is hydrogen, is an acidic group or salt thereof or is the monovalent organic radical containing one or two acidic groups or salts thereof.

Examples of acidic Pₐ groups are carboxylic acid radicals, sulfonic acid radicals, phosphoric acid radicals, phosphonic acid radicals or radicals of phosphorous acid, where one or two of these radicals are optionally connected to the rest of the molecule of the formula (I) via a bridging group, for example via an alkylene group —CₒH₂ₒ— or via an alkanone group —CO—(C_{q}H_{2q})—, in which o or q are integers from 1 to 6, preferably from 1 to 4. The bridging group may also have different acidic groups. In place of the acid radical, it is also possible to use salts thereof.

Preferably, Pₐ is hydrogen, —SO₃M, —CH₂COOM, PO₃M₂,

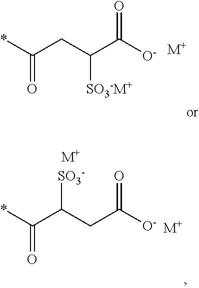

where the symbol “*” in the sulfosuccinate formulae means that the corresponding structural units are bonded via the bond indicated by the symbol to an oxygen atom an -A-O— group or of a —B—O— group.

The above-defined M radicals are hydrogen, a monovalent metal cation, NH₄⁺, a primary, secondary, tertiary or quaternary ammonium cation, or a combination thereof, or equivalents of di-, tri- or polyvalent metal cations.

Examples of monovalent metal cations are alkali metal cations, especially sodium or potassium cations.

Examples of divalent metal cations are alkaline earth metal cations, especially magnesium or calcium cations, or zinc cations.

Examples of trivalent metal cations are aluminum cations.

Examples of cations of primary amines are cations of monoalkylamines, especially of those having 1 to 6 carbon atoms in the alkyl group.

Examples of cations of secondary amines are cations of dialkylamines, especially of those having 1 to 6 carbon atoms in the alkyl group.

Examples of cations of tertiary amines are cations of trialkylamines, especially of those having 1 to 6 carbon atoms in the alkyl group.

Examples of quaternary ammonium cations are those having four alkyl groups, especially of those having 1 to 6 carbon atoms in the alkyl group.

Preferred M radicals are hydrogen, an alkali metal cation, NH₄⁺ or a quaternary ammonium cation.

The above-defined W_{b} and W_{c} radicals are preferably both oxygen.

The above-defined Yₐ and X_{c} radicals are independently a monovalent hydrocarbyl radical. These may be straight-chain or branched alkyl radicals, cycloalkyl radicals, or preferably aromatic or araliphatic radicals. These radicals may, as well as carbon and hydrogen, also contain one or more heteroatoms, such as nitrogen, oxygen or sulfur, especially nitrogen and/or oxygen.

Examples of alkyl radicals are those having 1 to 20 carbon atoms, in which one or more nonadjacent carbon atoms are optionally replaced by —O— or —NH—. Preference is given to alkyl radicals having 6 to 20 carbon atoms.

Examples of cycloalkyl radicals are those having 6 to 8 carbon atoms, in which one or more, preferably 1 or 2, ring carbon atoms are optionally replaced by oxygen atoms, sulfur atoms and/or nitrogen atoms. A preferred cycloalkyl radical is cyclohexyl.

Examples of aryl radicals are those having 6 to 18 carbon atoms, in which one or more, preferably 1 or 2, ring carbon atoms are optionally replaced by oxygen atoms, sulfur atoms and/or nitrogen atoms. A preferred aryl radical is phenyl.

Examples of aralkyl radicals are those which have 7 to 30 carbon atoms and have, as well as an aryl radical, an alkylene chain that establishes the connection to the rest of the molecule. A preferred aralkyl radical is benzyl.

Preferred Yₐ and X_{c} radicals are alkyl radicals or aralkyl radicals, especially phenyl or benzyl.

The above-defined zₐ, z_{b} and z_{c} radicals are independently hydrogen or (C₁-C₄)-alkyl, preferably hydrogen and methyl and most preferably hydrogen.

Examples of repeat structural units derived from an ethylenically unsaturated monomer that does not form any of the structural units of the formulae (I) to (IV) are those that derive from ethylenically unsaturated carboxylic acids or salts, anhydrides, amides or esters thereof other than acrylic acid or methacrylic acid or any derivatives of acrylic acid or of methacrylic acid, or those that derive from ethylenically unsaturated sulfonic acids or phosphonic acids or from the salts, anhydrides, amides or esters thereof, or those that derive from mono- or polyunsaturated aliphatic hydrocarbons.

The homo- and copolymers containing the repeat structural units of the formula (I) and optionally of the formulae (II), (III) and/or (IV) can be prepared by free-radical polymerization of monomers (A), optionally in combination with monomers (B), (C) and/or (D) and optionally in combination with further ethylenically unsaturated monomers that are not monomers of the formulae (A) to (D).

The molar proportions of the monomers (A) to (D) and of the optional further comonomers corresponds to the proportions of the repeat structural units derived from these monomers in the desired homo- or copolymer.

The monomers (A) can be described by the formula (Ia)

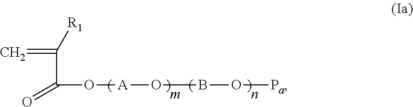

where R₁, A, B, Pₐ, m and n have the definitions given further up.

If both indices m and n are unequal to 0, the alkyleneoxy units (A-O)ₘ and (B—O)ₙ may be present either in block form or in random arrangement. Preferably, the alkyleneoxy units (A-O)ₘ and (B—O)ₙ are arranged in block form.

In a preferred embodiment of the invention, homo- or copolymers used as component ii) are those in which (A-O)ₘ represents propyleneoxy units and (B—O)ₙ represents ethyleneoxy units, or (A-O)ₘ represents ethyleneoxy units and (B—O)ₙ represents propyleneoxy units, where the molar proportion of the ethyleneoxy units is preferably 50% to 98%, more preferably 60% to 95% and especially preferably 70% to 95%, based on the sum total (100%) of the ethyleneoxy and propyleneoxy units.

The sum total of the alkyleneoxy units n+m is a number from 1 to 1000, preferably from 2 to 500, more preferably from 2 to 100 and especially preferably from 5 to 100.

The monomers (B) can be described by the formula (IIa)

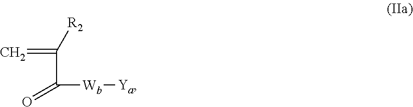

where R₂, W_{b} and Yₐ have the definitions given further up.

The monomers (C) can be described by the formula (IIIa)

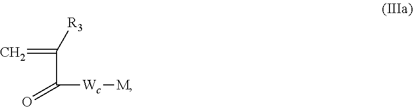

where R₃, W_{c} and M have the definitions given further up.

The monomers (D) can be described by the formula (IVa)

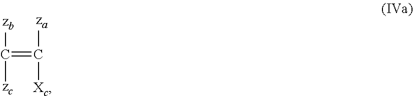

where zₐ, z_{b}, z_{c} and X_{c} have the definitions given further up.

The present invention preferably relates to suspensions comprising the above-defined components i), iii) and optionally iv), and also, as component ii), one or more copolymers selected from the group consisting of copolymers of the formula (CP₁) and copolymers of the formula (CP₂)

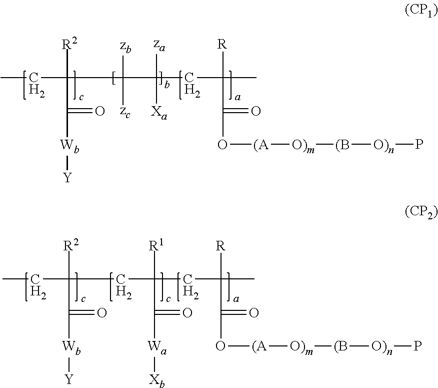

where
the indices a, b and c state the molar proportion of the respective structural unit,
a is 0.01-0.8,
b is 0.001-0.8,
c is 0.001-0.8, and
the sum of a+b+c is 1,
A is C₂-C₄-alkylene,
B is a C₂-C₄-alkylene other than A,
R is hydrogen or methyl,
m is a number from 0 to 500, preferably from 1 to 500,
n is a number from 0 to 500, preferably from 1 to 500, and
the sum of m+n is 1 to 1000, preferably 2 to 1000,
Xₐ is an aromatic or araliphatic radical which has 3 to 30 carbon atoms and
optionally contains one or more of the heteroatoms N, O and S,
zₐ is H or (C₁-C₄)-alkyl,
z_{b} is H or (C₁-C₄)-alkyl,
z_{c} is H or (C₁-C₄)-alkyl,
R¹ is hydrogen or methyl,
X_{b} is an aromatic or araliphatic radical which has 3 to 30 carbon atoms and optionally contains one or more of the heteroatoms N, O and S,
Wₐ is oxygen or the NH group,
R² is hydrogen or methyl,
Y is hydrogen or an aliphatic hydrocarbyl radical which has 1 to 30 carbon atoms and may be linear or branched, or else cyclic, and may contain the heteroatoms O, N and/or S and may also be unsaturated,
W_{b} is oxygen or the NH group,
P is H, SO₃M, CH₂COOM, PO₃M₂,

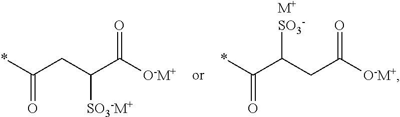

and
M is H, a polyvalent metal cation, a divalent metal cation, NH₄⁺, a secondary, tertiary or quaternary ammonium ion, or a combination thereof, or is equivalents of di-, tri- or polyvalent metal ions.

The symbol “*” in the sulfosuccinate formulae under the definition of “P” means that the corresponding structural units are bonded to the -(A-O)ₘ—(B—O)ₙ— group in the copolymer b) via the bond indicated by the symbol.

The nonionic copolymers of the formulae (CP₁) and (CP₂) in which P is H can be prepared by free-radical polymerization of monomers (A), (B) and (C) corresponding to the structural units described in the brackets [ ]_{c}, [ ]_{b} and [ ]ₐ. The preparation of the nonionic copolymers of the formulae (CP₁) and (CP₂) in which P is H is described in WO 2008/138485 A1. For preparation of the anionic copolymers of the formulae (CP₁) and (CP₂) in which P has a definition other than H, first of all, the nonionic copolymers of the formulae (CP₁) and (CP₂) in which P is H are prepared and the nonionic copolymers obtained are then converted by methods known to those skilled in the art to the corresponding anionic copolymers of the formulae (CP₁) and (CP₂) in which P has a definition other than H. The preparation of the anionic copolymers of the formulae (CP₁) and (CP₂) in which P has a definition other than H is described in WO 2008/138486 A1.

The molar proportion of the monomers, based on the total amount of the monomers (A), (B) and (C) used for preparation of the copolymers of component ii), is generally 1% to 80% for monomer (A), 0.1% to 80% for monomer (B), and 0.1% to 80% for monomer (C). Preferably, the molar proportion of the monomers, based on the total amount of the monomers (A), (B) and (C) used for preparation of the copolymers of component ii), is 10% to 70% for monomer (A), 10% to 60% for monomer (B), and 10% to 60% for monomer (C).

The monomers (A) can be described by the formula (I):

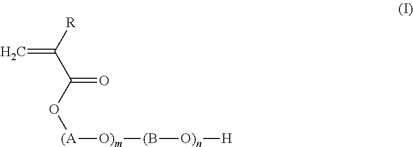

where
A is C₂- to C₄-alkylene and
B is a C₂- to C₄-alkylene other than A,
R is hydrogen or methyl,
m is a number from 1 to 500, preferably 1 to 50,
n is a number from 1 to 500, preferably 1 to 50, and
where the sum of m+n is 2 to 1000.

If both the alkyleneoxy units (A-O)ₘ and (B—O)ₙ are present in one molecule, these may either be in block form or in random arrangement. Preferably, the alkyleneoxy units (A-O)ₘ and (B—O)ₙ are arranged in block form.

In a preferred embodiment of the invention, copolymers of component ii) that are used are those in which (A-O)ₘ represents propyleneoxy units and (B—O)ₙ represents ethyleneoxy units, or (A-O)ₘ represents ethyleneoxy units and (B—O)ₙ represents propyleneoxy units, where the molar proportion of the ethyleneoxy units is preferably 50% to 98%, more preferably 60% to 95% and especially preferably 70% to 95%, based on the sum total (100%) of the ethyleneoxy and propyleneoxy units.

The sum total of the alkyleneoxy units n+m in the copolymers CP₁ and CP₂ is a number from 1 to 1000, preferably from 2 to 1000, more preferably from 2 to 500, even more preferably from 2 to 100 and especially preferably from 5 to 100.

The monomers (B) can be described by the formula (IIa) or formula (IIb):

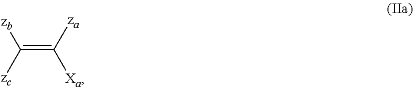

where
Xₐ is an aromatic or araliphatic radical which has 3 to 30 carbon atoms, preferably 6 to 30 and more preferably 6 to 20 carbon atoms, and optionally contains one or more of the heteroatoms N, O and S,
zₐ is H or (C₁-C₄)-alkyl,
z_{b} is H or (C₁-C₄)-alkyl and
z_{c} is H or (C₁-C₄)-alkyl,

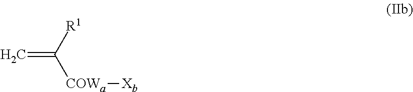

where
R¹ is hydrogen or methyl,
X_{b} is an aromatic or araliphatic radical which has 3 to 30 carbon atoms, preferably 6 to 30 and more preferably 6 to 20 carbon atoms, and optionally contains one or more of the heteroatoms N, O and S, and
Wₐ is oxygen or the NH group.

The monomers (B) of the formula (IIa) include, for example, vinylaromatic monomers such as styrene and derivatives thereof, for example vinyltoluene, alpha-methylstyrene. The aromatic unit may also include heteroaromatics, as, for example, in 1-vinylimidazole. The monomer (B) of the formula (IIa) is preferably styrene, meaning that zₐ, z_{b} and z_{c} are preferably H and Xₐ is preference phenyl.

The monomers (B) of the formula (IIb) are, for example, the following esters and amides of acrylic acid or methacrylic acid: phenyl, benzyl, tolyl, 2-phenoxyethyl, phenethyl.

In a particularly preferred embodiment of the invention, the monomers (B) are selected from: styrene, 1-vinylimidazole, benzyl methacrylate, 2-phenoxyethyl methacrylate and phenethyl methacrylate.

The monomers (C) can be described by the formula (III)

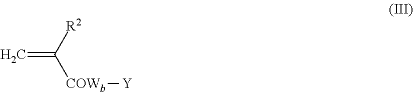

where
R² is hydrogen or methyl,
Y is an aliphatic hydrocarbyl radical which has 1 to 30, preferably 6 to 30 and more preferably 9 to 20 carbon atoms and may be linear or branched, or else cyclic, and may contain the heteroatoms O, N and/or S and may also be unsaturated, and

W_{b} is oxygen or the NH group.

The monomers (C) include, for example, the following esters and amides of acrylic acid or methacrylic acid: methyl, ethyl, propyl, isopropyl, n-butyl, isobutyl, tert-butyl, pentyl, hexyl, 2-ethylhexyl, 3,3-dimethylbutyl, heptyl, octyl, isooctyl, nonyl, lauryl, myristyl, cetyl, octadecyl or stearyl, behenyl, cyclohexyl, trimethylcyclohexyl, tert-butylcyclohexyl, bornyl, isobornyl, adamantyl, (2,2-dimethyl-1-methyl)propyl, cyclopentyl, 4-ethylcyclohexyl, 2-ethoxyethyl, tetrahydrofurfuryl and tetrahydropyranyl.

Preferred monomers (C) are the following alkyl esters or alkyl amides of acrylic acid and methacrylic acid: methyl, ethyl, propyl, n-butyl, isobutyl, 2-ethylhexyl, lauryl, myristyl, octadecyl and more preferably 2-ethylhexyl and lauryl.

In a particularly preferred embodiment of the invention, the one or more copolymers used as component ii) are copolymers of the formula (CP₁) or (CP₂) in which P is H.

In a further particularly preferred embodiment of the invention, the one or more copolymers b) used as component ii) are copolymers of the formula (CP₁) or (CP₂) in which P has a definition other than H.

The homo- and copolymers containing the repeat structural units of the formulae (I) and optionally (II), (III) and/or (IV) including the copolymers (CP₁) and (CP₂) preferably have a molecular weight of 10³ to 10⁹ g/mol, more preferably of 10³ to 10⁷ g/mol and especially preferably of 10³ to 10⁵ g/mol. They have customary terminal groups which result from the initiation of the free radical polymerization or from chain transfer reactions or from chain termination reactions, for example a proton, a group formed from a free-radical initiator or a sulfur-containing group from a chain transfer reagent.

The repeat structural units of the formula (I) and optionally of the formulae (II), (III) and/or (IV) and the structural units described in the brackets [ ]_{c}, [ ]_{b} and [ ]ₐ may be present in the one or more copolymers used as component ii), for example, in a block-type, random, gradient-type or alternating arrangement, and are preferably in a random arrangement.

Preferred suspensions comprise copolymers CP₁ and/or CP₂ as component ii), in which the P group is H,

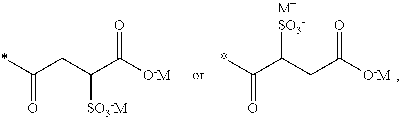

and

M is H, a polyvalent metal cation, a divalent metal cation, NH₄⁺, a secondary, tertiary or quaternary ammonium ion, or a combination thereof, or is equivalents of di-, tri- or polyvalent metal ions.

Most preferably, M in the one or more copolymers of component ii) is H or Na⁺.

Among the copolymers used as component ii), preference is given to the copolymers of the formula (CP₁).

The amount of the one or more homo- or copolymers containing the repeat structural units of the formula (I) and optionally (II), (III) and/or (IV), especially the copolymers of the formulae (CP₁) and (CP₂) of component ii) in the suspension of the invention, is preferably from 0.05% to 10% by weight, more preferably from 0.1% to 5% by weight and especially preferably from 0.2% to 3% by weight. These amounts are based on the total mass of the corresponding suspension of the invention.

The suspensions of the invention comprise one or more solvents iii). They may comprise, for example, water as the sole solvent, one or more organic solvents alone, for example one or more water-immiscible solvents, or else combinations of water and one or more organic solvents, for example combinations of water and one or more water-immiscible solvents. They may also comprise, for example, combinations of water with further water-miscible or water-soluble solvents.

In a further preferred embodiment of the invention, the amount of the one or more solvents iii) in the suspensions of the invention is preferably from 10% to 90% by weight, more preferably from 20% to 85% by weight, especially preferably from 30% to 80% by weight and most preferably from 30% to 60% by weight. These amounts are based on the total mass of the corresponding suspension of the invention.

If the suspensions of the invention comprise water and additionally one or more organic solvents, for example one or more water-immiscible solvents, the weight ratio of water to the one or more organic solvents, for example the one or more water-immiscible solvents, is from 50:1 to 1:50, more preferably from 20:1 to 1:20 and especially preferably from 10:1 to 1:10.

Preferred suspensions comprise

iii) water as the sole solvent, and

iv) optionally one or more further auxiliaries.

Further preferred suspensions comprise, as component iii), one or more water-immiscible solvents and either no water or water in an amount of not more than 1.0% by weight, based on the total weight of the suspension.

Still further preferred suspensions comprise, as component iii), water and one or more water-immiscible solvents.

Still further preferred suspensions comprise, as component iii), water and one or more water-miscible solvents.

Particular preference is given to suspensions in which the one or more solvents of component iii) are selected from the group consisting of water, monohydric alcohols and polyhydric alcohols and are preferably selected from water and from mixtures consisting of water and one or more further substances selected from the group consisting of monohydric alcohols and polyhydric alcohols.

The mono- or polyhydric alcohols used with particular preference include ethanol, ethylene glycol, propylene glycol, glycerol, butanol, octanol, polyethylene glycol, butylene glycol and singly end-capped diols, such as monomethyl, monoethyl, monopropyl or monobutyl ethers of glycols or polyethylene glycols.

If the suspensions of the invention comprise one or more auxiliaries iv), the amount thereof in the suspensions of the invention is preferably from 1% to 50% by weight, more preferably from 2% to 40% by weight and especially preferably from 4% to 30% by weight. These amounts are based on the total mass of the corresponding suspension of the invention.

Any auxiliaries iv) present in the suspensions of the invention may be dispersants, wetting agents, emulsifiers, thickeners, preservatives, adjuvants, penetrants, cold stabilizers, colorants, defoamers and/or antioxidants.

Suitable dispersants and wetting agents are all substances usable customarily for this purpose in agrochemical formulations, such as nonionic, amphoteric, cationic and anionic (polymeric) surfactants.

Preferred dispersants and wetting agents are fatty alcohol ethoxylates, fatty alcohol alkoxylates, EO/PO block copolymers (EO: ethyleneoxy unit; PO: propyleneoxy unit), alkylarylsulfonic acids, alkylsulfonic acids, sulfonic acids of ethoxylated alcohols, sulfosuccinates, fatty acid methyl taurides, tristyrylphenol ethoxylates and alkoxylates, tri-sec-butylphenol ethoxylates, sulfated cresol-formaldehyde condensation products, sulfated condensation products of naphthalene and alkylnaphthenes, lignosulfonates, phosphoric esters of ethoxylated fatty alcohols, tristyrylphenols and tri-sec-butylphenols, and also ether sulfates of ethoxylated fatty alcohols, tristyrylphenols and tri-sec-butylphenols and polymeric dispersants.

Suitable emulsifiers are nonionic and anionic emulsifiers such as ethoxylates or alkoxylates of long-chain (C₈ to C₂₄) linear or branched alcohols, EO/PO block copolymers (EO: ethyleneoxy unit; PO: propyleneoxy unit), alkylphenol or tristyrylphenol ethoxylates and alkoxylates, tri-sec-butylphenol ethoxylates, castor oil ethoxylates, esters of long-chain carboxylic acids with mono- or polyhydric alcohols and the ethoxylation products thereof, salts of dodecylbenzenesulfonic acid, sulfosuccinates, phosphoric esters of ethoxylated fatty alcohols, tristyrylphenols and tri-sec-butylphenols and salts thereof.

Thickeners used may be any substances typically usable for this purpose in agrochemical formulations, such as xanthan gum and/or cellulose, for example carboxy-, methyl-, ethyl- or propylcellulose, (optionally modified) bentonites or silicon dioxide, or thickening polymers or copolymers.

Preservatives used may be any substances typically usable for this purpose in agrochemical formulations, such as organic acids and esters thereof, for example ascorbic acid, ascorbyl palmitate, sorbate, benzoic acid, methyl and propyl 4-hydroxybenzoate, propionates, phenol, for example 2-phenylphenate, 1,2-benzisothiazolin-3-one, formaldehyde, sulfurous acid and salts thereof.

Adjuvants used may be any substances typically usable for this purpose in agrochemical formulations, such as optionally crosslinked polyglycerol esters, alcohol alkoxylates, for example alcohol ethoxylates, alkyl polysaccharides, fatty amine ethoxylates, esters of fatty acids, esters based on vegetable oils, esters of phosphorous acid or phosphoric acid, such as bis(ethylhexyl) ethylhexylphosphonate or tris(ethylhexyl) phosphate, and sorbitan ethoxylate and sorbitol ethoxylate derivatives.

Suitable penetrants are all substances that are typically used to improve the penetration of pesticides into plants or into target organisms. Penetrants may be defined, for example, by their ability to penetrate from the aqueous spray liquor and/or from a spray coating on the plant surface into the cuticle of the plant and hence to increase the mobility of active ingredients in the cuticle. The method described in the literature can be used to determine this property (Baur et al., 1997, Pesticide Science 51, 131-152).

Cold stabilizers used may be any substances customarily usable for this purpose in agrochemical formulations. Examples include urea, glycerol and propylene glycol. Suitable colorants are all substances typically usable for this purpose in agrochemical formulations, such as water- or oil-soluble dyes, and organic or inorganic pigments. Suitable defoamers are all substances customarily usable for this purpose in agrochemical formulations, such as fatty acid alkyl ester alkoxylates; organopolysiloxanes such as polydimethylsiloxanes and mixtures thereof with microfine, optionally silanized silica; perfluoroalkylphosphonates and -phosphinates; paraffins; waxes and microcrystalline waxes, and mixtures thereof with silanized silica. Also advantageous are mixtures of various foam inhibitors, for example those of silicone oil, paraffin oil and/or waxes. Useful antioxidants include all substances customarily usable for this purpose in agrochemical formulations, for example BHT (2,6-di-tert-butyl-4-methylphenol).

The suspensions of the invention preferably comprise one or more auxiliaries of component iv).

Preferred suspensions of the invention comprise, as component iv), one or more copolymers obtainable by copolymerizing glycerol, at least one dicarboxylic acid or a higher polybasic carboxylic acid, such as citric acid, and at least one monocarboxylic acid.

Preferably, these copolymers are obtainable by copolymerizing glycerol, at least one dicarboxylic acid and at least one monocarboxylic acid of the formula (V)

R⁴—COOH (V)

in which R⁴ denotes C₅-C₂₉-alkyl, C₇-C₂₉-alkenyl, phenyl or naphthyl. The proportion of the glycerol-derived structural units in the copolymer here is preferably 19.9-99% by weight, the proportion of the dicarboxylic acid-derived structural units in the copolymer is preferably 0.1% to 30% by weight, and the proportion of the structural units in the copolymer that are derived from the monocarboxylic acid of the formula (V) is preferably 0.9% to 8% by weight.

Copolymers of this kind are described in EP 1,379,129 B1.

Copolymers used with preference are those which have been prepared using, as dicarboxylic acid, oxalic acid, malonic acid, succinic acid, glutaric acid, adipic acid, pimelic acid, suberic acid, fumaric acid, maleic acid, phthalic acid, isophthalic acid and/or terephthalic acid.

Further copolymers used with preference are those which have been prepared using, as monocarboxylic acid of the formula V, fatty acids or mixtures thereof, especially coconut acid and/or tallow fatty acid.

Very particularly preferred suspensions of the invention contain the abovementioned components i), ii) and iii), and a copolymer obtainable by copolymerizing glycerol, phthalic acid and coconut fatty acid.

Exceptionally preferred suspensions of the invention comprise 30% to 50% by weight of component i), 0.2% to 3% by weight of component ii) and 30% to 60% by weight of component iii), based in each case on the total amount of the suspension.

The suspensions of the invention comprise, as component v), preferably one or more pesticides.

Further preferred suspensions of the invention do not contain any pesticide.

“Pesticides” are understood in the context of the present invention to mean herbicides, fungicides, insecticides, acaricides, bactericides, molluscicides, nematicides and rodenticides, and also phytohormones. Phytohormones control physiological reactions, such as growth, flowering rhythm, cell division and seed ripening. An overview of the most relevant pesticides can be found, for example, in “The Pesticide Manual” from the British Crop Protection Council, 14^{th} Edition 2006, editor: C D S Tomlin.

The one or more pesticides of component v) of the suspensions of the invention are preferably selected from the group consisting of herbicides, insecticides and fungicides.

Preferred fungicides are aliphatic nitrogen fungicides, amide fungicides such as acyl amino acid fungicides or anilide fungicides or benzamide fungicides or strobilurin fungicides, aromatic fungicides, benzimidazole fungicides, benzothiazole fungicides, carbamate fungicides, conazole fungicides such as imidazoles or triazoles, dicarboximide fungicides, dithiocarbamate fungicides, imidazole fungicides, morpholine fungicides, oxazole fungicides, pyrazole fungicides, pyridine fungicides, pyrimidine fungicides, pyrrole fungicides, quinone fungicides.

Preferred herbicides are amide herbicides, anilide herbicides, aromatic acid herbicides such as benzoic acid herbicides or picolinic acid herbicides, benzoylcyclohexanedione herbicides, benzofuranyl alkylsulfonate herbicides, benzothiazole herbicides, carbamate herbicides, carbanilate herbicides, cyclohexene oxime herbicides, cyclopropylisooxazole herbicides, dicarboximide herbicides, dinitroaniline herbicides, dinitrophenol herbicides, diphenyl ether herbicides, dithiocarbamate herbicides, imidazolinone herbicides, nitrile herbicides, organophosphorus herbicides, oxadiazolone herbicides, oxazole herbicides, phenoxy herbicides such as phenoxyacetic acid herbicides or phenoxybutanoic acid herbicides or phenoxypropionic acid herbicides or aryloxyphenoxypropionic acid herbicides, pyrazole herbicides such as benzoylpyrazole herbicides or phenylpyrazole herbicides, pyridazinone herbicides, pyridine herbicides, thiocarbamate herbicides, triazine herbicides, triazinone herbicides, triazole herbicides, triazolone herbicides, triazolopyrimidine herbicides, uracil herbicides, urea herbicides such as phenylurea herbicides or sulfonylurea herbicides.

Preferred insecticides are carbamate insecticides such as benzofuranylmethyl carbamate insecticides or dimethyl carbamate insecticides or oxime carbamate insecticides or phenyl methylcarbamate insecticides, diamide insecticides, insect growth regulators, macrocyclic lactone insecticides such as avermectin insecticides or milbemycin insecticides or spinosyn insecticides, nereistoxin analog insecticides, nicotinoid insecticides such as nitroguanidine nicotinoid insecticides or pyridylmethylamine nicotinoid insecticides, organophosphorus insecticides such as organophosphate insecticides or organothiophosphate insecticides or phosphonate insecticides or phosphoramidothioate insecticides, oxadiazine insecticides, pyrazole insecticides, pyrethroid insecticides such as pyrethroid ester insecticides or pyrethroid ether insecticides or pyrethroid oxime insecticides, tetramic acid insecticides, tetrahydrofurandione insecticides, thiazole insecticides.

Examples of plant growth regulators include natural and synthetic plant hormones such as abscisic acid, benzyladenine, caprylic acid, decanol, indoleacetic acid, jasmonic acid, salicylic acid and esters thereof, gibberellic acid, kinetin and brassinosteroids.

Preferred growth regulators are natural and synthetic plant hormones selected from the group consisting of alcohols, preferably decanol, auxins, preferably indoleacetic acid, cytokinins, preferably benzyladenine, fatty acids, preferably caprylic acid, gibberellins, preferably gibberellic acid, jasmonates, preferably jasmonic acid or esters thereof, sesquiterpenes, preferably abscisic acid, and salicylic acid or esters thereof.

Biological control agents are known to those skilled in the art and are described, for example, in “The Manual of Biocontrol Agents: A World Compendium, Copping, L. G., BCPC 2009”.

More preferably, the one or more pesticides of component v) of the suspensions of the invention are selected from the group consisting of triazole fungicides, strobilurin fungicides, neonicotinoid insecticides, phenylpyrazole insecticides, benzoylcyclohexanedione herbicides, triazine herbicides and sulfonylurea herbicides.

Especially preferably, the one or more pesticides of component v) of the suspensions of the invention are selected from the group consisting of epoxiconazole, tebuconazole, azoxystrobin, trifloxystrobin, imidacloprid, thiacloprid, thiamethoxam, fipronil, ethiprole, mesotrione, tembotrione, atrazine, nicosulfuron, iodosulfuron and mesosulfuron.

The suspensions of the invention comprise the one or more pesticides of component v) preferably in an amount of 1% to 80% by weight, more preferably in an amount of 5% to 70% by weight and especially preferably in an amount of 10% to 60% by weight. These amounts are based on the total mass of the corresponding suspension of the invention.

Suspensions in the context of this invention shall be understood to mean all dispersions of plant nutrients i) and optionally of pesticides v), irrespective of whether the solvent present is water alone, an organic solvent alone or a combination of both solvents, i.e. of water and an organic solvent.

Preference is given to suspension concentrates; in the context of the present description, this means a suspension wherein the solids content, based on the total mass of the suspension, is at least 20% by weight.

In the narrower sense, suspension concentrates are often understood to mean aqueous dispersions of pesticides only. These are typically abbreviated to “SC”. In the context of the present invention, suspension concentrates, however, are understood to mean the concentrates more broadly defined above.

In a further preferred embodiment of the invention, the suspension concentrates of the invention therefore comprise
i) one or more plant nutrients,
ii) one or more homo- or copolymers containing the above-defined repeat structural units of the formula (I) and optionally of the formula (II), (III) and/or (IV), preferably copolymers selected from the group consisting of copolymers of the above-defined formula (CP₁) and copolymers of the above-defined formula (CP₂),
iii) water as the sole solvent,
iv) optionally one or more further auxiliaries and
v) one or more pesticides that are solid at room temperature (25° C.).

The production of stable aqueous suspension concentrates is particularly demanding when, as well as the water-insoluble pesticide dispersed in water, one or more further water-soluble pesticides are present. These water-soluble pesticides (such as glyphosate) have the character of a salt, which leads to problems in the dispersants that are customarily used, which is manifested by thickening of the suspension concentrate or separation into multiple phases or precipitation.

Surprisingly, the homo- or copolymers containing the repeat structural units of the formula (I) and optionally the repeat structural units of the formula (II), (III) and/or (IV), and especially the copolymers (CP₁) and (CP₂), are also of particularly good suitability for production of suspension concentrates comprising, as well as the one or more dispersed pesticides that are solid at room temperature, one or more water-soluble salt-type pesticides.

In a preferred embodiment of the invention, the suspensions comprise one or more pesticides v), at least one of which is water-soluble and at least one of which is optionally water-insoluble.

“Water solubility” here means a solubility in water of more than 50 g/L at room temperature (25° C.); and “water insolubility” means a solubility in water of less than 50 g/L at room temperature (25° C.). The same applies to water-soluble plant nutrients and to water-insoluble plant nutrients.

In a further preferred embodiment of the invention, the suspensions of the invention therefore comprise
i) one or more plant nutrients,
ii) one or more homo- or copolymers containing the above-defined repeat structural units of the formula (I) and optionally of the formula (II), (III) and/or (IV), preferably copolymers selected from the group consisting of copolymers of the above-defined formula (CP₁) and copolymers of the above-defined formula (CP₂),
iii) water as the sole solvent,
iv) optionally one or more further auxiliaries,
v) one or more pesticides that are solid at room temperature (25° C.), and
va) one or more water-soluble pesticides other than the pesticides v), having a solubility in water of more than 50 g/L at room temperature (25° C.).

More preferably, the one or more water-soluble pesticides va) are selected from water-soluble salts of herbicides, and they are especially preferably selected from the group consisting of water-soluble salts of N-phosphonomethylglycine (glyphosate), glufosinate, 2,4-D, dicamba, bentazone and MCPA.

If the suspensions of the invention contain one or more water-soluble pesticides v2) having a solubility in water of more than 50 g/L at room temperature, the amount thereof in the suspension concentrates of the invention is preferably from 0.1% to 50% by weight, more preferably from 1% to 40% by weight and especially preferably from 5% to 30% by weight. These amounts are based on the total mass of the corresponding suspension concentrate of the invention.

As well as the aqueous suspensions, there also exist anhydrous suspensions. These are also known by the name “oil dispersions” (abbreviated to “OD”). In oil dispersion, the pesticides and plant nutrients are dispersed in a water-immiscible solvent (the “oil”). However, the oil need not be an oil in the conventional sense (such as a mineral oil or vegetable oil). Instead, this is understood to mean any water-immiscible solvent. This formulation form is particularly suitable, for example, for hydrolysis-sensitive active ingredients, for example sulfonylurea herbicides, which break down with time in the presence of water. In addition, oil dispersions have the advantage that they often feature higher biological efficacy. Particular neonicotinoid insecticides are therefore also formulated relatively frequently as an oil dispersion.

In a further preferred embodiment of the invention, the suspensions of the invention therefore comprise
i) one or more plant nutrients,
ii) one or more homo- or copolymers containing the above-defined repeat structural units of the formula (I) and optionally of the formula (II), (III) and/or (IV), preferably copolymers selected from the group consisting of copolymers of the above-defined formula (CP₁) and copolymers of the above-defined formula (CP₂),
iii) one or more water-immiscible solvents,
iv) optionally one or more further auxiliaries, and
v) one or more pesticides that are solid at room temperature (25° C.), and

have the characteristic feature that they either contain no water or contain water in an amount of not more than 1.0% by weight, based on the total weight of the particular suspension.

“Anhydrous” is understood in the context of the present invention to mean suspensions that either contain no water or contain water in an amount of not more than 1.0% by weight, based on the total weight of the particular suspension. Preferably, the anhydrous suspensions of the invention contain less than 0.5% by weight of water, based on the total weight of the particular suspension. These water contents typically result from residual amounts of water that are present in the solvents or auxiliaries used and are introduced in the course of production of the compositions as an impurity during the process.

Water-immiscible solvents in the context of this invention are understood to mean solvents that have a solubility at room temperature (25° C.) of not more than 5% by weight, preferably of not more than 1% by weight, in water.

Examples of such solvents are alkanes, aromatic hydrocarbons, solvent naphtha, alcohols, esters, ketones, amides, ethers, phosphoric and phosphonic esters, vegetable oils, mineral oils, alkyl esters of fatty acids of vegetable or animal origin.

Preference is given to solvent naphtha, fatty acid amides, vegetable oils, mineral oils and short-chain esters of fatty acids of vegetable or animal origin.

In addition, there also exists suspensions comprising both water and water-immiscible solvents. These are referred to as suspoemulsions (SE). It is possible here that only the aqueous phase comprises at least one pesticide and at least one plant nutrient in dispersed form. In that case, water-immiscible solvents and auxiliaries (for example emulsifiers) are present in the nonaqueous phase. However, suspoemulsions often contain at least one pesticide and/or at least one plant nutrient both in the aqueous phase and in the nonaqueous phase. In that case, at least one sparingly soluble pesticide and/or at least one sparingly soluble plant nutrient are in dispersed form in the aqueous phase, and at least one pesticide soluble in the solvent and/or at least one soluble plant nutrient in dissolved form in the solvent phase of the water-immiscible solvent.

In a further preferred embodiment of the invention, the suspensions of the invention therefore comprise
i) one or more plant nutrients that are solid at room temperature (25° C.),
ii) one or more homo- or copolymers containing the above-defined repeat structural units of the formula (I) and optionally of the formula (II), (III) and/or (IV), preferably copolymers selected from the group consisting of copolymers of the above-defined formula (CP₁) and copolymers of the above-defined formula (CP₂),
iii) water and one or more water-immiscible solvents,
iv) optionally one or more further auxiliaries, and
v) one or more pesticides that are solid at room temperature (25° C.).

Preferred auxiliaries iv) in the context of this invention are copolymers as described in WO 02/089575 A1. These auxiliaries have the advantage that they have both wetting and dispersing action and can additionally function as an adjuvant.

In a further preferred embodiment of the invention, the suspensions of the invention therefore comprise
i) one or more plant nutrients that are solid at room temperature (25° C.),
ii) one or more homo- or copolymers containing the above-defined repeat structural units of the formula (I) and optionally of the formula (II), (III) and/or (IV), preferably copolymers selected from the group consisting of copolymers of the above-defined formula (CP₁) and copolymers of the above-defined formula (CP₂),
iii) one or more solvents,
iv) one or more copolymers obtainable by copolymerizing glycerol, at least one dicarboxylic acid or higher polyhydric carboxylic acid and at least one monocarboxylic acid and optionally one or more further auxiliaries other than these copolymers, and
v) one or more pesticides that are solid at room temperature (25° C.).

Preferably, the copolymers of component iv) that have just been mentioned are copolymers obtainable by copolymerizing
α) 19.9% to 99% by weight of glycerol,
β) 0.1% to 30% by weight of at least one dicarboxylic acid and
γ) 0.9% to 80% by weight of at least one monocarboxylic acid of the abovementioned formula (V).

The dicarboxylic acid β) is preferably oxalic acid or a dicarboxylic acid of formula (VI)

HOOC—R⁵—COOH (VI)

and/or a dicarboxylic acid of formula (III)

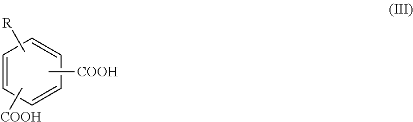

where R⁵ represents a (C₁-C₄₀)-alkylene bridge or a (C₂-C₂₀)-alkenylene bridge and R is H, (C₁-C₂₀)-alkyl, (C₂-C₂₀)-alkenyl, phenyl, benzyl, halogen, —NO₂, (C₁-C₆)-alkoxy, —CHO or —CO((C₁-C₆)-alkyl).

In a particularly preferred embodiment of the invention, the dicarboxylic acid β) is phthalic acid and the monocarboxylic acid γ) is coconut fatty acid.

If the suspensions of the invention contain one or more copolymers obtainable by copolymerizing glycerol, at least one dicarboxylic acid and at least one monocarboxylic acid, the amount thereof in the suspension concentrates of the invention is preferably from 0.1% to 25% by weight, more preferably from 0.5% to 20% by weight and especially preferably from 1% to 15% by weight. These amounts are based on the total mass of the corresponding suspension concentrate of the invention.

The suspensions of the invention are advantageously suitable for use as plant fertilizers.

The content of agrochemical substances (plant nutrients and optionally pesticides) in the use forms prepared from the crop treatment compositions can vary within wide limits. The concentration of the agrochemical substances in the use forms, especially in the spray liquors, may typically be between 0.00000001% and 95% by weight of agrochemical substance, preferably between 0.00001% and 5% by weight of agrochemical substance, more preferably between 0.00001% and 1% by weight of agrochemical substance and especially preferably between 0.001% and 1% by weight of agrochemical substance, based on the weight of the use form, especially of the spray liquor. Application is accomplished in a customary manner appropriate to the use forms.

The formulations are produced, for example, by mixing the components with one another in the particular ratios desired. If the agrochemical substance is a solid substance, it is generally used either in finely ground form or in the form of a solution or suspension in an organic solvent or water. If the agrochemical substance is liquid, there is frequently no need to use an organic solvent. It is also possible to use a solid agrochemical substance in the form of a melt. The temperatures can be varied within a particular range in the course of performance of the process. In general, working temperatures are between 0° C. and 80° C., preferably between 10° C. and 60° C.

According to the formulation type, the production of the crop treatment compositions used in accordance with the invention is possible in various ways which are sufficiently well known to those skilled in the art. The procedure in the production may, for example, be to mix the polymers of component ii) with one or more agrochemical substances and optionally with auxiliaries. The sequence in which the components are mixed with one another is arbitrary. Useful equipment in the production is customary equipment which is used for production of agrochemical formulations.

For production of the suspensions of the invention, the polymers of component ii) may also be used in the form of solid formulations together with plant nutrients, such as SGs (“soluble granules”, water-soluble granules), WGs (“wettable granules”, water-dispersible granules) and WPs (“wettable powders”, water-dispersible powders).

In the use of the invention, crop treatment compositions are preferably deployed in the form of spray liquors. This preferably involves production of a spray liquor by dilution of a concentrate formulation with a defined amount of water.

The invention further provides a spray liquor obtainable by diluting the above-described suspension concentrates with water.

The invention further provides a method of fertilizing plants, in which the plants or the habitat thereof is brought into contact with one of the above-described suspensions or with one of the above-described spray liquors.

The invention further relates to use of the above-described suspensions for fertilization of plants or for production of spray liquors for the fertilization of plants, and also to the use of these spray liquors for fertilization of plants.

### EXAMPLES

The invention is illustrated hereinafter by examples, but these should in no way be regarded as a restriction.

The commercial products used are:

| | |
|---|---|
| Genapol ® X-060 | ethoxylated alcohol, C11-14-iso-, C13-rich |
| | (6EO) from Clariant |
| Dispersogen ® LFS | triethanolammonium salt of an ethoxylated |
| | TSP phosphate from Clariant (96% by |
| | weight); TSP: tristyrylphenol |
| Kelzan ® S | xanthan gum from CP Kelco (thickener) |
| SILFOAM ® SRE-PFL | silicone defoamer from Wacker-Chemie |
| Calcium formate, 98% | Ca formate from Alfa Aesar |

General Method for Production of Suspension Concentrates:

All components (except for the Kelzan® S solution) are predispersed with a dissolver. The subsequent fine grinding is effected in a ball mill until the desired particle size has been attained. Subsequently, the aqueous Kelzan® S solution is added and adjusted to the desired final viscosity.

In the case of the suspoemulsion, the water-immiscible solvent is pre-emulsified together with emulsifier and water separately from the aqueous plant nutrient suspension and likewise added only after the dispersion step.

The target particle size is a value between 1 and 50 μm; the particle sizes are preferably in the range of 5 to 30 μm, more preferably between 6 and 20 μm.

The viscosity of the final suspensions at room temperature is typically within a range from 100 to 500 mPas (Brookfield) at 100 rpm, or 900 to 2000 mPas at 20 rpm.

Testing of the Suspensions:

The suspensions are stored at −10° C., 0° C., 20° C., 30° C. and 40° C. for at least 4 weeks. Merely a minimal amount of sediment is to be formed here, which must additionally be redispersible.

After equilibration of the stored samples to room temperature, it is checked by gently agitating the samples whether a solid or redispersible sediment has formed.

### Example 1: Suspension with Calcium Formate (450 g/L)

| | | |
|---|---|---|
| 35.43 | g | calcium formate |
| 2.0 | g | Genapol X 060 |
| 1.0 | g | copolymer (prepared according to synthesis |
| | | example 19 from WO 2008/138486 A1) |
| 2.0 | g | copolymer (prepared according to the method for |
| | | copolymer II from EP 1 379 129 B1, 70% by weight |
| | | solution in water) |
| 8.0 | g | Kelzan ® S (2% by weight solution in water) |
| 6.0 | g | 1,2-propylene glycol |
| 0.25 | g | Silfoam ® SRE-PFL |
| 45.32 | g | deionized water |

### Example 2: Suspension with Calcium Formate (450 g/L)

| | | |
|---|---|---|
| 35.43 | g | calcium formate |
| 2.0 | g | Genapol X 060 |
| 0.5 | g | copolymer (prepared according to synthesis |
| | | example 3 from WO 2008/138485 A1) |
| 2.0 | g | copolymer (prepared according to the method for |
| | | copolymer II from EP 1 379 129 B1, 70% by weight |
| | | solution in water) |
| 5.75 | g | Kelzan ® S (2% by weight solution in water) |
| 6.0 | g | 1,2-propylene glycol |
| 0.25 | g | Silfoam ® SRE-PFL |
| 48.07 | g | deionized water |

### Example 3: Suspension with Calcium Formate (450 g/L)

| | | |
|---|---|---|
| 35.43 | g | calcium formate |
| 2.0 | g | Genapol X 060 |
| 0.5 | g | copolymer (prepared according to synthesis |
| | | example 19 from WO 2008/138486 A1) |
| 5.75 | g | Kelzan ® S (2% by weight solution in water) |
| 6.0 | g | 1,2-propylene glycol |
| 0.25 | g | Silfoam ® SRE-PFL |
| 50.07 | g | deionized water |

### Example 4: Suspension with Calcium Formate (450 g/L)

| | | |
|---|---|---|
| 35.43 | g | calcium formate |
| 2.0 | g | Genapol X 060 |
| 1.0 | g | copolymer (prepared according to synthesis |
| | | example 3 from WO 2008/138485 A1) |
| 5.75 | g | Kelzan ® S (2% by weight solution in water) |
| 6.0 | g | 1,2-propylene glycol |
| 0.25 | g | Silfoam ® SRE-PFL |
| 49.57 | g | deionized water |

### Example 5: Suspension with Calcium Formate (450 g/L); Comparative Example

| | | |
|---|---|---|
| 35.43 | g | calcium formate |
| 2.0 | g | Genapol X 060 |
| 1.0 | g | Dispersogen LFS |
| 2.0 | g | copolymer (prepared according to the method for |
| | | copolymer II from EP 1 379 129 B1, 70% by weight |
| | | solution in water) |
| 5.75 | g | Kelzan ® S (2% by weight solution in water) |
| 6.0 | g | 1,2-propylene glycol |
| 0.25 | g | Silfoam ® SRE-PFL |
| 47.57 | g | deionized water |

Results of the Storage Experiment (4 Weeks):

| | Example | | | | |
|---|---|---|---|---|---|
| | 1 | | | | |
| | Proportion of the | | | | 5 |
| Storage | suspension phase after | | | | (comparative |
| temperature | storage (% by volume) | 2 | 3 | 4 | example) |
| −10° C. | 70 | 70 | 71 | 69 | 64 |
| 0° C. | 74 | 68 | 86 | 72 | 21 |
| 20° C. | 89 | 95 | 86 | 81 | 44* |
| 30° C. | 90 | 91 | 95 | 83 | 54* |
| 40° C. | 82 | 83 | 70 | 75 | 54 |

*sediment not redispersible by simple agitation

Further Examples of Suspensions of the Invention:

### Example 6: Plant Nutrient Suspension

| | | |
|---|---|---|
| 17.0 | g | calcium formate |
| 8.0 | g | ammonium dihydrogenphosphate |
| 10.0 | g | potassium nitrate |
| 2.0 | g | magnesium sulfate heptahydrate |
| 1.0 | g | iron(II) sulfate |
| 2.0 | g | copolymer (prepared according to synthesis |
| | | example 19 from WO 2008/138486 A1) |
| 6.0 | g | 1,2-propylene glycol |
| 2.0 | g | Genapol X 060 |
| 5.75 | g | Kelzan ® S (2% by weight solution in water) |
| 0.25 | g | Silfoam ® SRE-PFL 46 g deionized water |

### Example 7: Plant Nutrient Suspension

| | | |
|---|---|---|
| 18.4 | g | calcium formate |
| 4.4 | g | urea |
| 2.2 | g | potassium nitrate |
| 2.0 | g | magnesium sulfate |
| 3.2 | g | magnesium nitrate |
| 1.4 | g | ammonium nitrate |
| 0.6 | g | ammonium chloride |
| 3.9 | g | ammonium dihydrogenphosphate |
| 0.5 | g | iron DTPA chelate |
| 0.2 | g | manganese EDTA chelate |
| 0.3 | g | zinc EDTA chelate |
| 0.04 | g | potassium borate |
| 0.04 | g | copper EDTA chelate |
| 0.01 | g | sodium molybdate |
| 0.01 | g | cobalt sulfate |
| 1.8 | g | copolymer (prepared according to synthesis |
| | | example 19 from WO 2008/138486 A1) |
| 5.0 | g | 1,2-propylene glycol |
| 2.0 | g | Genapol X 060 |
| 8.0 | g | Kelzan 2% solution |
| 46.0 | g | water |

1. A suspension comprising
i) at least one plant nutrient,
ii) at least one copolymer containing
1 to 80 mol % of at least one repeat structural unit of the formula (I) 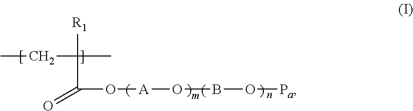
0.1 to 80 mol % of at least one repeat structural unit of the formula (II) 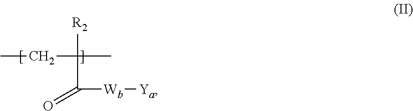
0 to 20 mol % of at least one repeat structural unit of the formula (III) 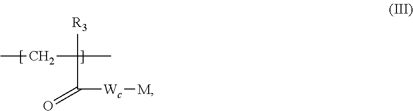
0.1 to 80 mol % of at least one repeat structural unit of the formula (IV) 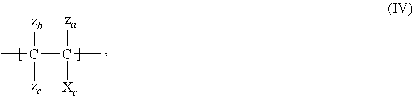
in which
R₁, R₂, and R₃ are independently hydrogen or methyl,
A is C₂-C₄-alkylene,
B is a C₂-C₄-alkylene other than A,
m is a number from 0 to 500,
n is a number from 0 to 500, and
the sum of m+n is 1 to 1000,
Pₐ is hydrogen, is an acidic group or salt thereof or is the monovalent organic radical containing one or two acidic groups or salts thereof,
W_{b} and W_{c} are independently oxygen or the NH group,
Yₐ and X_{c} are independently a monovalent hydrocarbyl radical, especially an aliphatic, aromatic or araliphatic radical optionally containing one or more of the heteroatoms N, O and S,
M is hydrogen or a monovalent metal cation, NH₄⁺, a primary, secondary, tertiary or quaternary ammonium cation, or a combination thereof, or is equivalents of di-, tri- or polyvalent metal cations, and
zₐ, z_{b} and z_{c} are independently hydrogen or (C₁-C₄)-alkyl, with the proviso that the sum total of the repeat structural units of the formula (I), (II), (III) and/or (IV), based on the overall homo- or copolymer, is at least 80 mol %,
iii) at least one solvent, and
iv) optionally one or more further auxiliaries.

2. The suspension as claimed in claim 1, wherein the at least one plant nutrient of component i) comprises trace elements in combination with nitrogen and/or potassium and/or phosphorus.

3. The suspension as claimed in claim 1, wherein the at least one plant nutrient of component i) comprises a soluble calcium salt having a solubility of more than 1 g/liter at pH values of 3.0 to 6.5.

4. The suspension as claimed in claim 1, which comprises, as component ii), at least one copolymer selected from the group consisting of copolymers of the formula (CP₁) and copolymers of the formula (CP₂) 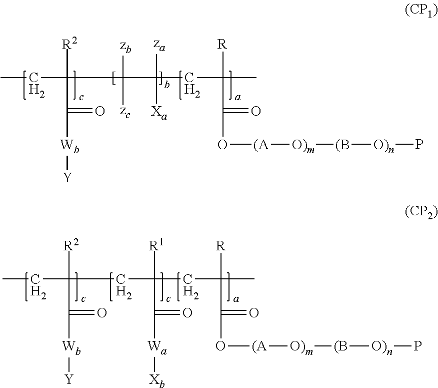
where
the indices a, b and c state the molar proportion of the respective structural unit,
a is 0.01-0.8,
b is 0.001-0.8,
c is 0.001-0.8, and
the sum of a+b+c is 1,
A is C₂-C₄-alkylene,
B is a C₂-C₄-alkylene other than A,
R is hydrogen or methyl,
m is a number from 0 to 500,
n is a number from 0 to 500, and
the sum of m+n is 1 to 1000,
Xₐ is an aromatic or araliphatic radical which has 3 to 30 carbon atoms and optionally contains one or more of the heteroatoms N, O and S,
zₐ is H or (C₁-C₄)-alkyl,
z_{b} is H or (C₁-C₄)-alkyl,
z_{c} is H or (C₁-C₄)-alkyl,
R¹ is hydrogen or methyl,
X_{b} is an aromatic or araliphatic radical which has 3 to 30 carbon atoms and optionally contains one or more of the heteroatoms N, O and S,
W is oxygen or the NH group,
R² is hydrogen or methyl,
Y is hydrogen or an aliphatic hydrocarbyl radical which has 1 to 30 carbon atoms and may be linear or branched, or else cyclic, and may contain the heteroatoms O, N and/or S and may also be unsaturated,
W_{b} is oxygen or the NH group,
P is H, SO₃M, CH₂COOM, PO₃M₂, 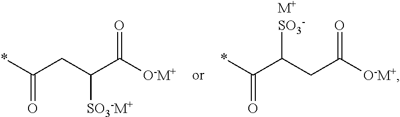
and
M is H, a polyvalent metal cation, a divalent metal cation, NH₄⁺, a secondary, tertiary or quaternary ammonium ion, or a combination thereof, or is equivalents of di-, tri- or polyvalent metal ions.

5. The suspension as claimed in claim 1, comprising
iii) water as the sole solvent, and
iv) optionally one or more further auxiliaries.

6. The suspension as claimed in claim 1, which comprises, as component iii), at least one water-immiscible solvent and comprises either no water or comprises water in an amount of not more than 1.0% by weight, based on the total weight of the suspension.

7. The suspension as claimed in claim 1, wherein the at least one solvent of component iii) is selected from the group consisting of water, monohydric alcohols, polyhydric alcohols, and mixtures thereof.

8. The suspension as claimed in claim 7, wherein the at least one solvent is selected from the group consisting of ethanol, ethylene glycol, propylene glycol, glycerol, butanol, octanol, polyethylene glycol, butylene glycol, singly end-capped diols, monomethyl, monoethyl, monopropyl or monobutyl ethers of glycols, polyethylene glycols, and mixtures thereof.

9. The suspension as claimed in claim 1, which comprises one or more further auxiliaries of component iv).

10. The suspension as claimed in claim 1, which comprises, as component iv), at least one copolymer obtainable by copolymerization of glycerol, at least one dicarboxylic acid or a higher polybasic carboxylic acid, and at least one monocarboxylic acid.

11. The suspension as claimed in claim 10, wherein the copolymer is obtainable by copolymerizing glycerol, at least one dicarboxylic acid and at least one monocarboxylic acid of the formula (V)
R⁴—COOH (V)
in which R⁴ denotes C₅-C₂₉-alkyl, C₇-C₂₉-alkenyl, phenyl or naphthyl.

12. The suspension as claimed in claim 11, which comprises components i), ii) and iii) and a copolymer obtainable by copolymerizing glycerol, phthalic acid and coconut fatty acid as component iv).

13. The suspension as claimed in claim 1, which comprises 30% to 50% by weight of component i), 0.2% to 3% by weight of component ii) and 30% to 60% by weight of component iii), based in each case on the total amount of the suspension.

14. The suspension as claimed in claim 1, further comprising at least one pesticide as component v).

15. The suspension as claimed in claim 1, which is free of pesticides.

16. The suspension as claimed in claim 1, which is a suspension concentrate having a proportion of solid substances of at least 20% by weight, based on the total mass of the suspension concentrate.

17. A spray liquor obtainable by diluting the suspension concentrate as claimed in claim 16 with water.

18. A method of fertilizing plants, characterized in that the plants or the habitat thereof are/is brought into contact with a suspension as claimed in claim 1.

19. (canceled)

20. (canceled)

21. A method of fertilizing plants, characterized in that the plants or the habitat thereof are/is brought into contact with a spray liquor as claimed in claim 17
